(19) United States
(12) Patent Application Publication
(10) Pub. No.: US 2014/0165474 A1
(43) Pub. Date: Jun. 19, 2014

(54) Titanium Diboride Composition in PCBN

(71) Applicant: DIAMOND INNOVATIONS, INC, Worthington, OH (US)

(72) Inventor: Nelson YEE, Hilliard, OH (US)

(73) Assignee: DIAMOND INNOVATIONS, INC, Worthington, OH (US)

(21) Appl. No.: 13/974,607

(22) Filed: Aug. 23, 2013

Related U.S. Application Data
(60) Provisional application No. 61/696,124, filed on Aug. 31, 2012.

(51) Int. Cl. C04B 35/5831

(52) U.S. Cl. CPC C04B 35/5831
USPC 51/307

(57) ABSTRACT

A composition of a sintered superhard compact is provided. The sintered superhard compact body may comprise superhard particles, such as cubic boron nitride. The binder phase may bond the superhard particles together. The binder phase comprises a titanium compound and a balance aluminum compound. The titanium compound may be formed during the high pressure high temperature condition. The sintered superhard compact body may have an amount of the titanium compound in order to have a mixed wear and toughness application.

### CROSS-REFERENCE TO RELATED APPLICATIONS

This application claims priority of provisional application, No. 61/696,124, filed Aug. 31, 2012, titled “Titanium Diboride Composition in PcBN”.

### TECHNICAL FIELD AND INDUSTRIAL APPLICABILITY

The present disclosure relates to a sintered superhard material made from powdered composition suitable for use in the manufacture of superhard abrasive compacts, and specifically to a sintered body containing cubic boron nitride (cBN) which may be used in cutting tools enhanced wear and toughness.

Polycrystalline cubic boron nitride (PcBN), diamond and diamond composite materials are commonly used to provide a superhard cutting surface for cutting tools such as those used in metal machining.

The cBN cutting tool is subject to erosion or wear and requires chemical and thermal resistance for optimizing the cutting rate on a working piece and lifetime of the tool.

Therefore, there is a need for a new composition in the material in order to produce a superhard compact having mixed superior wear and toughness characteristics.

### SUMMARY

In one embodiment, a sintered superhard compact body may comprise superhard particles; and a binder phase bonding the superhard particles together, wherein the binder phase comprises a titanium compound and a balance aluminum compound, wherein the sintered superhard compact body has an amount of the titanium compound in order to have a mixed wear and toughness application.

In another embodiment, a PcBN compact body comprise at least 35% by volume of cubic boron nitride (cBN) particles, wherein cBN particles have average particle size distribution (PSD) from about 0.1 μm to about 5 μm; and a binder phase bonding the cubic boron nitride particles together, wherein the binder phase comprises a titanium compound and a balance aluminum compound.

In yet another embodiment, a PcBN compact body comprises cubic boron nitride particles; and a binder phase bonding the cubic boron nitride particles together, wherein the binder phase comprises titanium diboride, wherein the titanium diboride is defined as the XRD peak height of the titanium diboride (101) peak, after background correction, being at least about 15% of the peak height of the (111) cBN.

### BRIEF DESCRIPTION OF THE DRAWINGS

The foregoing summary, as well as the following detailed description of the embodiments, will be better understood when read in conjunction with the appended drawings. It should be understood that the embodiments depicted are not limited to the precise arrangements and instrumentalities shown.

FIG. 1 is an XRD trace of titanium diboride in PcBN compact body after back-ground correction according to an exemplary embodiment.

### DETAILED DESCRIPTION

An exemplary embodiment provides a sintered superhard compact body with a binder phase comprises titanium compound and a balanced aluminum compound. The superhard particles may be selected from a group of cubic boron nitride, diamond, and diamond composite materials. The composition of starting material used in producing the polycrystalline cBN compact comprises cBN and a binder phase, in powder or particular green compact form. The binder phase may at least partially melt and react with cBN and form bonding by reaction sintering during high pressure and high temperature (HPHT) sintering.

An exemplary embodiment may improve the toughness of a cBN material with an increased wear resistance. A superhard sintered compact and a method for its production that provides significantly improved microstructural homogeneity and better wear and toughness than other superhard sintered compacts.

Exemplary embodiments provide cBN compacts, more specifically, to a cBN compact comprising cBN and a matrix phase incorporating a titanium-based binder phase and a balanced aluminum compound. The cBN compacts may comprise 15% to 40% titanium compound, such as titanium diboride comparable to cBN particles, defined as the XRD peak height of the titanium diboride (101) peak compared to cBN (111) peak, after background correction.

Titanium diboride may be typically present in the cBN compact as a result of the reaction between cBN and the secondary hard phase which contains titanium compound. The titanium diboride may act as bonding agent among cBN grains or cBN grains and binder grains. Titanium diboride has a high melting point of about 3000° C., an excellent hardness of about 24 GPa and a high Young's modulus compared to other materials. Titanium diboride has a good abrasion resistance as well as an oxidation resistance at a high temperature.

In manufacturing the inventive sintered cBN compacts, feedstock powder may be blended with the desired particle size and mixed by a variety of techniques. Dispersion of cBN particles is mainly accomplished during the milling or blending step. Milling, in general, as a means of comminution and dispersion, is well known in the art. Commonly used milling techniques in grinding ceramic powder include conventional ball mills, tumbling ball mills, planetary ball mills, attritor mills, and agitated ball mills. In conventional ball milling, the energy input is determined by the size and density of the milling media, the diameter of the milling pot and the speed of rotation. Since the method requires that the balls tumble, rotational speeds, and therefore energy are limited. Conventional ball milling is well suited for milling powders with low to medium particle strength. Typically, conventional ball milling is used where powders are to be milled to a final particle size around 1 micron or more.

In planetary ball milling, the planetary motion of the milling pots allows acceleration up to 20 times the gravitational acceleration. When dense milling bodies are used, this allows for substantially more energy in milling compared to conventional ball milling. This technique is well suited for comminution with particles of moderate strength, with final particle sizes of around 1 micron.

In one exemplary embodiment, superhard particles may comprise at least about 35% by volume superhard particles, such as cBN, for example. In another exemplary embodiment, superhard particles may comprise from about 35% to about 70% by volume cBN. The sintered superhard compact body may further comprise a binder phase bonding the superhard particles together. The binder phase may comprise titanium compound, such as titanium diboride, titanium nitride, titanium carbide, titanium carbonitride, for example, and a balance aluminum compound, such as aluminum nitride or aluminum oxide.

Titanium diboride may be formed during high pressure high temperature condition, wherein the titanium compound may be mixed with superhard particles, such as cBN, suitable for mixed wear and toughness application.

In one exemplary embodiment, the sintered superhard particles may have average particle size distribution (PSD) at least about 0.1 μm, for example. In another exemplary embodiment, the sintered superhard particles may have PSD from about 0.1 μm to about 5 μm, for example.

The cBN based material is sintered in a high pressure, high temperature (HPHT) process. Phase transitions during the HPHT process result in generating new phases, such as, borides, nitrides and carbonitrides, for example. In one exemplary embodiment, titanium diboride may be formed between titanium nitride and superhard particles, such as cBN.

X-Ray examination of the cBN compact materials may be carried out using a vertical diffractometer fitted with Cu radiation with generator settings of 40 kV and 45 mA. Typically, XRD scans may be carried out between 20 to 65 degrees 2 theta range, with a step size of 0.02 degrees 2 theta, with 5 seconds per step. Collected XRD scans were background-corrected and Ka-2 stripped before full-width-half-maximum (FWHM) measurements. FWHM measurements may be done after curve-fitting the data and determining peak position. Peak heights may be measured directly after identifying the peak position. CBN peak height may be measured on the (111) plane; whereas Titanium diboride may be measured on (101) plane.

In an exemplary embodiment of a process to make a superhard compact, raw superhard materials, such as cBN, may be blended by a milling process with fluids and ceramic materials which comprises stoichiometric or substoichiometric carbides, nitrides, oxides, or combinations thereof from aluminum, titanium or other transition metals of group IV, V, or VI in the periodic table of elements. After milling, the powder may be loaded in refractory metal cups (e.g., Ta, or Nb). The size of the cups may limit the size of the final sintered compact. A support material (powder or compact) may be loaded into the cup for in situ bonding to the sintered cBN compact. Suitable substrates include, for example, tungsten carbide. Crimping the cup material around the edge of the substrate may seal the cup.

The blank then may be loaded into a high pressure cell which include pressure transmission and pressure sealing materials and then subjected to high pressure (e.g., 10-80 kbar) and high temperature (about 1000-1900° C.) for a predetermined time period, such as 10-90 minutes, for example, to sinter the powder mixture and braze it to the desired dimensions. The sintered blank is removed from the cell and machined to remove the cup material and to bring it to the desired dimensions. The finished blank is sufficiently electrically conductive that it may be cut by electro-discharge machining (EDM) into shapes and sizes suitable for the manufacture of cutting tools used for machining powder metal iron and other similar materials. The size and shape of the described sintered blanks may be varied by changing the dimensions of the components and are primarily limited in dimension by high pressure/high temperature (HPHT) equipment used to promote the sintering process.

### Example 1

Base materials, such as substoichiometric TiN, TiC, Al, and cBN of desired particle size distribution were measured (65% volume cBN, 27% volume Ti-based materials, 8% volume Al). The mixture was roughly blended by hand. Tungsten carbide media were loaded into an attritor mill. Milling fluid was added to generate a sufficient slurry viscosity. As the attritor mill ran at a low speed, the roughly blended powder composition was added to the attritor mill and blended for a predetermined time to yield to a sufficient level of blending.

The slurry was sieved and dried. The powder was recovered and coarsely sieved. The powder was measured and poured into a metal cup, such as Ta, Mo, or Nb cup. A tungsten carbide substrate was placed on top of powder and the cup was sealed. The loaded cup was heat treated in an inert atmosphere and loaded into a HPHT cell. The loaded cup was HPHT processed at a predetermined pressure and temperature for a defined period of time to achieve sufficient reaction and sintering. The sintered blank was machined to remove the cup material and to bring to the desired dimensions (3.2 mm thick and 59 mm diameter, for example). The finished blank was sufficiently electrically conductive such that it was cut by electro discharge machining (EDM) into shapes and sizes suitable for the manufacture of cutting tools used for machining ferrous based powder metal and other similar materials.

### Example 2

Base materials, such as TiCN, and cBN of desired particle size distribution were measured (65% by volume cBN, 27% volume TiCN, 8% volume Al) and pre-treated by heat and/or chemicals, such as organics, acids, or bases, under predefined atmospheres. The mixture was roughly blended by hand. Tungsten carbide media were loaded into an attritor mill. Milling fluid, such as a polar protic liquid, was added to generate a sufficient slurry viscosity. As the attritor mill ran at a low speed, the roughly blended powder composition was added to the attritor mill and blended for a predetermined time to yield a sufficient level of blending.

The aluminum was added to a calculated volume of polar protic liquid to achieve a final slurry viscosity suitable for granulation. A mixer was started to disperse the aluminum in the liquid. The blended cBN and TiCN powder was added to the aluminum-liquid mixture and mixed for a predetermined time to yield sufficient blending and viscosity for the slurry. A polymer based material, such as polyethylene glycol or polyvinyl butyral, was added to the mixture as a binder for granulation. The mixture was granulated and pressed into a green compact.

The green compact was heated in a defined atmosphere, and then placed into a metal cup, such as Ta, Mo, Nb cup. The tungsten carbide substrate was placed on the top of the compact and the cup was sealed. The loaded cup was loaded into a HPHT cell. The loaded cup was HPHT processed at a predetermined pressure and temperature for a defined period of time to achieve sufficient reaction and sintering. The sintered blank was machined to remove the cup material and to bring to the desired dimensions (3.2 mm thick and 59 mm diameter, for example). The finished blank was sufficiently electrically conductive such that it was cut by electro discharge machining (EDM) into shapes and sizes suitable for the manufacture of cutting tools used for machining ferrous based powder metal and other similar materials.

### Example 3

Base materials, such as substoichiometric TiN, Al, and cBN of desired particle size distribution were measured (65% by volume cBN, 27% volume Ti-based materials, 8% volume Al). The mixture was roughly blended by hand. Tungsten carbide media were loaded into a ball mill, for example. Milling fluid, such as a non-polar liquid, was added to generate a sufficient slurry viscosity for granulation. As the attritor mill ran at a low speed, the roughly blended powder composition was added to the attritor mill and blended for a predetermined time to yield to a sufficient level of blending.

The slurry was sieved. A polymer based material, such as polyethylene glycol or polyvinyl butyral, to the slurry as a binder for granulation. Additional liquid was added to achieve a final slurry viscosity for granulation. The mixture was granulated and pressed into a green compact.

The green compact was heated in a defined atmosphere, and then placed into a metal cup, such as Ta, Mo, or Nb. The tungsten carbide substrate was placed on the top of the compact and the cup was sealed. The loaded cup was loaded into a HPHT cell. The loaded cup was HPHT processed at a predetermined pressure and temperature for a defined period of time to achieve sufficient reaction and sintering. The sintered blank was machined to remove the cup material and to bring to the desired dimensions (3.2 mm thick and 59 mm diameter, for example). The finished blank was sufficiently electrically conductive such that it was cut by electro discharge machining (EDM) into shapes and sizes suitable for the manufacture of cutting tools used for machining powder metal iron and other similar materials.

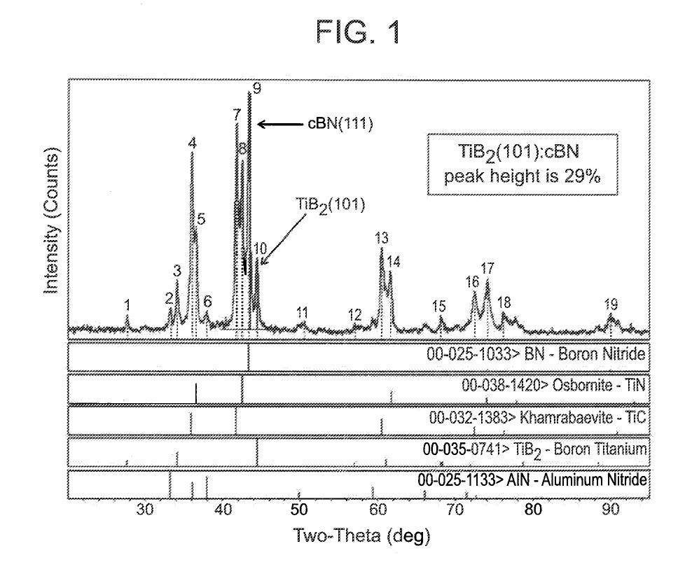

As shown in FIG. 1, the XRD pattern of a PcBN composition of Example 1 initially containing 65 vol % cBN with an average particle size distribution (PSD) in the range from about 0.1 μm to about 5 μm, a 27 vol % mixture of substoichiometric TiN and stoichiometric TiC, and 8% vol Al. The composition was HPHT processed in a cBN-stable pressure and temperature range. The cBN, TiN, and TiC peak patterns for components in the starting composition are present alongside those of reaction products, such as AIN and TiB₂ from HPHT processing. The peak height and peak area ratios of TiB₂<101> peak located at ca. 44.4 degrees and cBN<111> peak located at ca. 43.4 degrees are 28.7 and 28.8%, respectively. The peak height and peak area ratios for TiB₂<101>:cBN<111> are characteristic of the final HPHT processed PcBN composition.

The full width half maximum (FWHM) measurement for Titanium diboride may be at least 0.3 degrees two theta. As shown in FIG. 1, FWHM measurements for cBN and TiB₂ are 0.359 and 0.354 respectively.

Although the present invention has been described in relation to particular embodiments thereof, many other variations and modifications and other uses will become apparent to those skilled in the art. It is preferred therefore, that the present invention be limited not by the specific disclosure herein, but only by the appended claims.

We claim:

1. A sintered superhard compact body, comprising:
superhard particles; and
a binder phase bonding the superhard particles together, wherein the binder phase comprises a titanium compound and a balance aluminum compound, wherein the titanium compound is formed during the high pressure high temperature condition, wherein the sintered superhard compact body has an amount of the titanium compound in order to have a mixed wear and toughness application.

2. The sintered superhard compact body of claim 1, wherein the sintered superhard compact contains at least about 35% by volume superhard particles.

3. The sintered superhard compact body of claim 1, wherein the sintered superhard compact contains from about 35% to about 70% by volume superhard particles.

4. The sintered superhard compact body of claim 1, wherein the sintered superhard particles have average particle size distribution (PSD) at least about 0.1 μm.

5. The sintered superhard compact body of claim 1, wherein the sintered superhard particles have average particle size distribution (PSD) from about 0.1 μm to about 5 μm.

6. The sintered superhard compact body of claim 1, wherein titanium compound comprises titanium diboride.

7. The sintered superhard compact body of claim 6, wherein the titanium diboride is defined as the XRD peak height of the titanium diboride (101) peak, after background correction, being at least 15% of the peak height of the (111) superhard particle peak.

8. The sintered superhard compact body of claim 1, wherein the binder phase further comprises at least one of titanium carbide, titanium nitride, titanium carbonitride.

9. The sintered superhard compact body of claim 6, wherein titanium diboride is formed between titanium nitride, titanium carbide, or titanium carbonitride and superhard particles.

10. The sintered superhard compact body of claim 1, wherein the aluminum compound comprises aluminum nitride.

11. The sintered superhard compact body of claim 1, wherein the titanium diboride is defined as the XRD peak height of the titanium diboride (101) peak, after background correction, being from about 15% to about 40% of the peak height of the (111) superhard particle peak.

12. The sintered superhard compact body of claim 1, wherein the superhard particle comprises at least one of cubic boron nitride, diamond, diamond composite materials.

13. The sintered superhard compact body of claim 1, wherein a XRD peak for the titanium compound has a full width half maximum value of at least 0.3 degrees 2 theta.

14. A PcBN compact body, comprising:
cubic boron nitride particles; and
a binder phase bonding the cubic boron nitride particles together, wherein the binder phase comprises titanium diboride, wherein the titanium diboride is defined as the XRD peak height of the titanium diboride (101) peak, after background correction, being at least about 15% of the peak height of the (111) cBN peak.

15. The PcBN compact body of claim 14, wherein the cBN compact contains at least about 35% by volume cBN particles.

16. The PcBN compact body of claim 14, wherein the cBN compact contains from about 35% to about 70% by volume cBN particles.

17. The PcBN compact body of claim 14, wherein the cBN particles have average particle size distribution (PSD) at least about 0.1 μm.

18. The PcBN compact body of claim 14, wherein the cBN particles have average particle size distribution (PSD) from about 0.1 μm to about 5 μm.

19. The PcBN compact body of claim 14, wherein the binder phase further comprises at least one of titanium carbide, titanium nitride, titanium carbonitride.

20. The PcBN compact body of claim 14, the titanium compound is formed during the high pressure high temperature condition.

21. The PcBN compact body of claim 14 further comprises a balance aluminum compound.

22. The PcBN compact body of claim 14, wherein the aluminum compound comprises aluminum nitride.

23. The PcBN compact body of claim 14, wherein the titanium diboride is defined as the XRD peak height of the titanium diboride (101) peak, after background correction, being from about 15% to about 40% of the peak height of the (111) cBN peak.

24. The PcBN compact body of claim 14, wherein a XRD peak for the titanium diboride has a full width half maximum (FWHM) value of at least 0.3 degrees 2 theta.

25. A PcBN compact body, comprising:
at least 35% by volume of cubic boron nitride (cBN) particles, wherein cBN particles have average particle size distribution (PSD) from about 0.1 μm to about 5 μm; and
a binder phase bonding the cubic boron nitride particles together, wherein the binder phase comprises a titanium compound and a balance aluminum compound.

26. The PcBN compact body of claim 25, wherein the cBN compact contains from about 35% to about 70% by volume cBN particles.

27. The PcBN compact body of claim 25, wherein titanium compound comprises titanium diboride.

28. The PcBN compact body of claim 25, wherein the titanium diboride is defined as the XRD peak height of the titanium diboride (101) peak, after background correction, being at least about 15% of the peak height of the (111) cBN peak.

29. The PcBN compact body of claim 25, wherein the binder phase further comprises at least one of titanium carbide, titanium nitride, titanium carbonitride.

30. The PcBN compact body of claim 25, wherein titanium dibromide is formed between titanium nitride and cBN particles.

31. The PcBN compact body of claim 25, wherein the aluminum compound comprises aluminum nitride

32. The PcBN compact body of claim 25, wherein the titanium diboride is defined as the XRD peak height of the titanium diboride (101) peak, after background correction, being from about 15% to about 40% of the peak height of the (111) cBN peak.
